(19) United States
(12) Patent Application Publication
(10) Pub. No.: US 2003/0226524 A1
(43) Pub. Date: Dec. 11, 2003

(54) Bazmi's six stroke engine

(76) Inventor: Alireza Ziabazmi, Pittsburgh, PA (US)

Correspondence Address: ALIREZA ZIABAZMI, 8363 VAN BUREN DRIVE, PITTSBURGH, PA, 15237, US

(21) Appl. No.: 10/164,659

(22) Filed: Jun. 10, 2002

(51) Int. Cl. F02B 75/02

(52) U.S. Cl. 123/64

(57) ABSTRACT

The invention concerns reciprocating piston internal combustion engines and in particular six-stroke type, FIG. 1. In this engine, one cycle comprises an intake stroke, a compression stroke, a power stroke, an exhaust stroke, the fifth stroke and the sixth stroke. In this engine, all combustion chamber valves A, B, C and D FIGS. 1 and 2 function as both intake valves in the intake stroke and exhaust valves in the exhaust stroke. The name of the valves A, B, C and D is intake-exhaust valves or (inlet-outlet valves). Intake ports 1, 2, 3 and 4 and exhaust ports 5, 6, 7 and 8 are connected to each other in the cylinder head 22 of the engine. As a result, fuel-air mixture is drawn into a cylinder 21 via the intake ports 1, 2, 3 and 4 and all combustion chamber valves (intake-exhaust valves) A, B, C and D in the intake stroke and exhaust gases are expelled from the cylinder via the same valves (intake-exhaust valves) and the exhaust ports 5, 6, 7 and 8 in the exhaust stroke. Therefore, the area of the valves and ports of the engine increases up to one hundred percent with respect to the area of the valves and ports used in a traditional engine. This improves engine efficiency and reduces undesirable engine emissions. In this engine, there are especial exhaust valves E and F installed in the cylinder head 22 out of the combustion chamber. These exhaust valves open in the exhaust stroke and close in the intake stroke to provide a one-way flow of fuel-air mixture sucked into the cylinder 21 via the intake ports 1, 2, 3 and 4 and the intake-exhaust valves A, B, C and D in the intake stroke and exhaust gases expelled from the cylinder via the same intake-exhaust valves and from the cylinder head via the exhaust ports 5, 6, 7 and 8 in the exhaust stroke. The fifth and the sixth strokes are considered in this engine to provide an interval between the exhaust stroke and the intake stroke of the next cycle. The exhaust gases driven out of the cylinder in the exhaust stroke are expelled completely from the cylinder head within the interval. Therefore, the exhaust gases are not sucked into the cylinder in the intake stroke of the next cycle. Especial cams and cam lobes are designed for this engine to close the intake-exhaust valves at the end of the exhaust stroke and to open them at the beginning of the intake stroke of the next cycle within the interval. This invention is practicable in a gasoline engine, a diesel engine and also in multi-cylinder engines.

### BACKGROUND OF THE INVENTION

The invention relates to reciprocating piston internal combustion engines and in particular to six-stroke type. Some of reciprocating internal combustion engines are of two-stroke type, but most of them are of four-stroke type. There are four strokes in one cycle in a four-stroke engine, namely an intake stroke, a compression stroke, a power stroke and an exhaust stroke respectively. There are various modes of cycling the intake and exhaust gases during the operation of six-stroke engines to improve energy efficiency.

There should be at least two valves in each cylinder. One valve is an intake valve that opens in intake strokes and the other is an exhaust valve that opens in exhaust strokes. In order to increase engine efficiency, the area of the intake and exhaust valves and ports should be increased so that more fuel-air mixture is introduced into the cylinder in the intake stroke and more exhaust gases are expelled from the cylinder in the exhaust stroke. That is why piston internal combustion engines with three, four or five valves per cylinder are manufactured. It is to be noted that in a five valve per cylinder engine the area of each valve is less than that of a two valve per cylinder engine providing the cylinders and displacement of both engines are considered the same.

### SUMMARY OF THE INVENTION

The main object of the invention is to increase the area of the intake and exhaust valves and ports in order to generate a large power and torque and also improve engine efficiency. The novelty of the invention is that all combustion chamber valves function as both intake valves and exhaust valves; in other words, in the intake stroke fuel-air mixture goes into a cylinder via the intake ports and all of the four combustion chamber valves and in the exhaust stroke exhaust gases are expelled from the cylinder via the same combustion chamber valves. The intake ports and exhaust ports are connected to each other in the cylinder head. Therefore, in this engine the area of the intake and exhaust valves and ports increases up to one hundred percent with respect to the area of the intake and exhaust valves and ports in an ordinary four valve per cylinder engine. It should be noted that the name of said combustion chamber valves is intake-exhaust valves or (inlet-outlet valves).

In order to provide a one-way flow of fuel-air mixture sucked into the cylinder via the intake ports and the intake-exhaust valves in the intake stroke and exhaust gases expelled from the cylinder and cylinder head via the same intake-exhaust valves and the exhaust ports in the exhaust stroke, especial exhaust valves are installed in the cylinder head out of the combustion chamber. Said exhaust valves close in the intake stroke and open in the exhaust stroke. As a result, in the exhaust stroke, exhaust gases do not go into the intake ports in the cylinder head.

There is a need for an interval so as to expel exhaust gases completely from the cylinder head. There is also a need for a mechanism to close the combustion chamber valves (intake-exhaust valves) at the end of the exhaust stroke and open them at the beginning of the intake stroke of the next cycle within the interval. Therefore, the fifth stroke and the sixth stroke are considered for the engine related to the invention; in other words, the engine operates on a six-stroke cycle. The six-stroke cycle consists of an intake stroke, a compression stroke, a power stroke, an exhaust stroke, the fifth stroke and the sixth stroke respectively.

The invention is feasible in both gasoline engines and diesel engines. The invention is also practicable in multi-cylinder engines.

Especial cams are designed for the valves of the engine. The radius and circumference of said cams are fifty percent larger than the radius and circumference of the traditional ones used in a four-stroke engine in order to cover all of the six strokes. In that case, there is no need to change the camshaft-to-crankshaft gear ratio used in a traditional four-stroke engine. The cams of the combustion chamber valves (intake-exhaust valves) have at least two cam lobes. These two cam lobes are considered for the intake stroke and the exhaust stroke. Third cam lobe is considered for only two cams of two intake-exhaust valves. The third cam lobe opens said two valves of the combustion chamber valves (intake-exhaust valves) in the middle of the fifth stroke and closes them in the middle of the sixth stroke in order to prevent pressure inside the cylinder from reducing while a piston moves downward at the end of the fifth stroke and moves upward at the beginning of the sixth stroke.

Other especial cams are also designed for the exhaust valves, which are in the cylinder head out of the combustion chamber. These cams are designed in a manner that said exhaust valves open at the beginning of the exhaust stroke and close in the middle of the sixth stroke. Said exhaust valves close in the middle of the sixth stroke so that the exhaust gases are expelled completely from the cylinder head within the fifth stroke and the first half of the sixth stroke.

### BRIEF DESCRIPTION OF THE DRAWINGS

FIG. 1 is a vertical cross-sectional view of the cylinder and cylinder head related to the invention.

FIG. 2 is a horizontal cross-sectional view showing the ports and valve seats of the cylinder head.

FIG. 3 is a view of the cam exclusive for the combustion chamber valves (intake-exhaust valves) A, B, C and D. Said cam is shown by 24 in FIG. 1.

FIG. 4 is a view of the cam exclusive for the exhaust valves E and F, which are in the cylinder head out of the combustion chamber. Said cam is marked with 23 in FIG. 1.

FIG. 5 is a view of a traditional cam used in a four-stroke engine.

FIG. 6 is a front view of a crankshaft especially designed for a six-stroke four-cylinder engine related to the invention.

FIG. 7 is a right view of the FIG. 6.

FIG. 8 is a 3D perspective view of the FIG. 7.

FIG. 9 is an exploded view of the FIG. 8.

FIG. 10 shows a rocker arm with a ratio of 1 to 1.8 marked with G to H.

### DETAILED DESCRIPTION OF THE INVENTION

In the drawings, reference characters referring to combustion chamber valves (intake-exhaust valves) are A, B, C and D for clarity. In addition, reference characters used for exhaust valves, which are in a cylinder head out of the combustion chamber, are E and F.

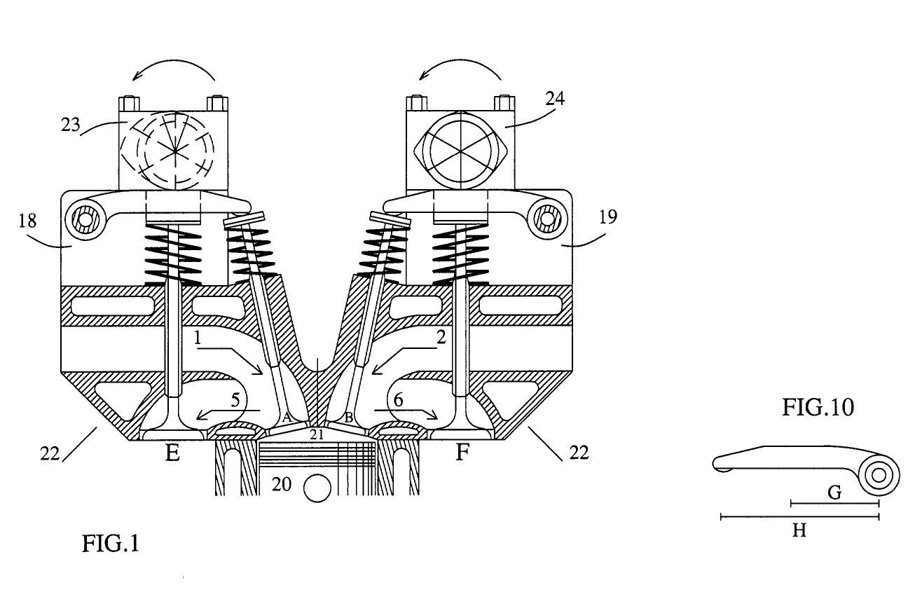

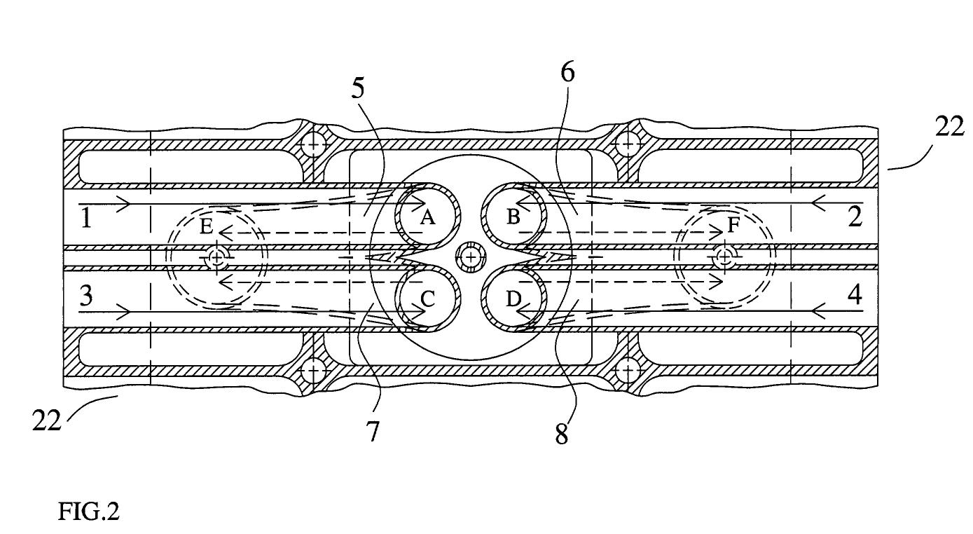

Referring to FIGS. 1 and 2, in an intake stroke the four combustion chamber valves (intake-exhaust valves) A, B, C and D are open and the exhaust valves E and F are closed. As a result, in the intake stroke, fuel-air mixture is drawn into a cylinder 21 via intake ports 1, 2, 3 and 4 and the intake-exhaust valves A, B, C and D. In a compression stroke and a power stroke, all of the intake-exhaust valves A, B, C and D are closed and also the exhaust valves E and F remain closed. In an exhaust stroke, the intake-exhaust valves A, B, C and D open again. The exhaust valves E and F also open in the exhaust stroke. As a result, in the exhaust stroke, the exhaust gases are expelled from the cylinder 21 and the cylinder head 22 via the same valves A, B, C and D and exhaust ports 5, 6, 7 and 8 and the exhaust valves E and F. The exhaust ports 5 and 7 are connected to the exhaust valve E, and the exhaust ports 6 and 8 are connected to the exhaust valve F in the cylinder head 22.

Closing of the exhaust valves E and F and opening of the intake-exhaust valves A, B, C and D in the intake stroke and opening of the exhaust valves E and F and also opening of the intake-exhaust valves A, B, C and D in the exhaust stroke effect a one-way flow of fuel-air mixture drawn into the cylinder head 22 and the cylinder 21 via the intake ports 1, 2, 3 and 4 in the intake stroke and exhaust gases expelled from the cylinder and cylinder head via the exhaust ports 5, 6, 7 and 8 and exhaust valves E and F in the exhaust stroke. Therefore, in the exhaust stroke exhaust gases do not go into the intake ports in the cylinder head. Of course, one-way valves like Reeds (not shown) can be utilized in the intake ports 1, 2, 3 and 4 to improve the continuity of said one-way flow.

There is a need for an interval so that the exhaust gases are expelled completely from the cylinder head and are not sucked into the cylinder in the intake stroke of the next cycle. There is also a need for a mechanism to close the intake-exhaust valves A, B, C and D at the end of the exhaust stroke and open them at the beginning of the intake stroke of the next cycle within the interval. Thus, the fifth stroke and the sixth stroke are considered for the engine. Therefore, the engine operates on a six-stroke cycle. On the fifth stroke, a piston 20 moves downward from a top dead center to a bottom dead center, and on the sixth stroke the piston moves upward from the bottom dead center to the top dead center.

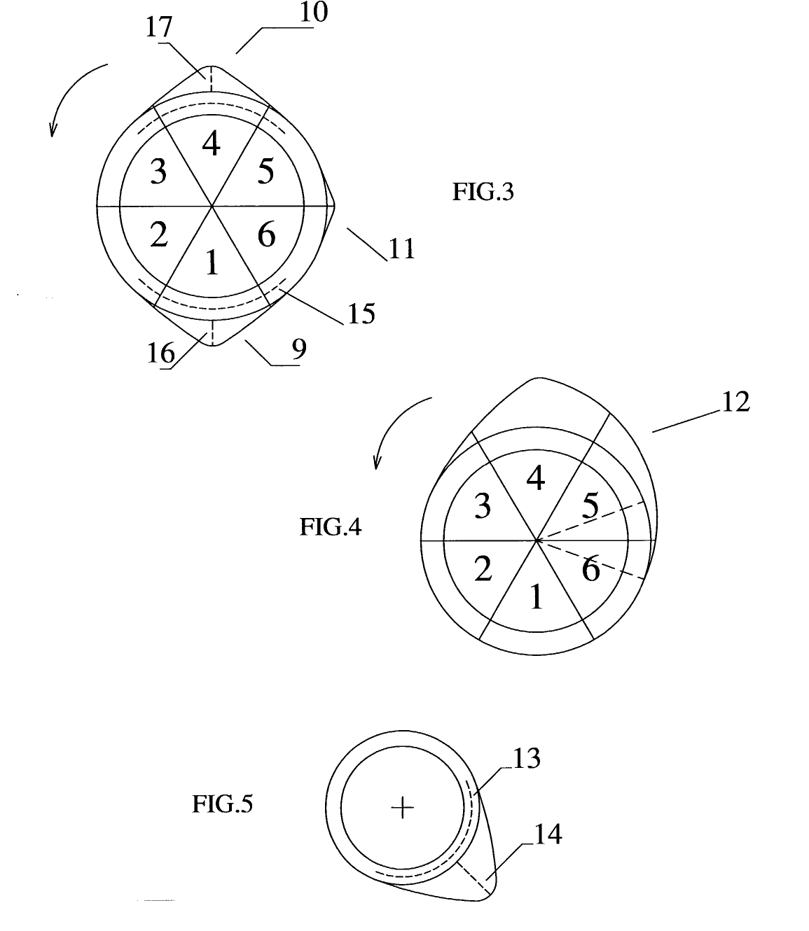

FIG. 3 shows a cam exclusive for the intake-exhaust valves A, B, C and D. There are three cam lobes on the cam. The cam lobe 9 is designed to open the intake-exhaust valves A, B, C and D in the intake stroke. The cam lobe 10 is designed to open the same valves in the exhaust stroke. The cam lobe 11 is designed only for two cams of two intake-exhaust valves A and D. The cam lobe 11 is designed to open the valves A and D approximately in the middle of the fifth stroke and close them in the middle of the sixth stroke. It should be noted that the intake-exhaust valves B and C are closed during the fifth and the sixth strokes.

FIG. 4 shows a cam exclusive for the exhaust valves E and F. There is a cam lobe 12 on the cam. The cam lobe 12 is designed to open the exhaust valves E and F at the beginning of the exhaust stroke. The cam lobe 12 causes said valves to begin closing in the middle of the exhaust stroke and close them completely in the middle of the sixth stroke.

The intake-exhaust valves A, B, C and D close at the end of the exhaust stroke, but the exhaust valves E and F stay open. The fresh air going into the cylinder head via the intake ports 1, 2, 3 and 4 expels remained exhaust gases in the exhaust ports 5, 6, 7 and 8 completely from the cylinder head within the fifth stroke and the first half of the sixth stroke.

In order to prevent the pressure inside the cylinder 21 from reducing while the piston 20 moves downward in the second half of the fifth stroke and moves upward in the first half of the sixth stroke, the two intake-exhaust valves A and D open in the middle of the fifth stroke and close in the middle of the sixth stroke. The fresh air is drawn into the cylinder during the second half of the fifth stroke and expelled from the cylinder during the first half of the sixth stroke along with the exhaust gases remained in the combustion chamber from the exhaust stroke of the previous cycle. It causes the exhaust gases, which are remained in the combustion chamber from the previous exhaust stroke, to be expelled from the cylinder. This improves the engine efficiency and also reduces the proportion of unbumt fractions in the exhaust gases.

Due to the suction caused by the previous intake stroke, even in the exhaust stroke, fresh air is introduced into the cylinder head via the intake ports 1, 2, 3 and 4 and is expelled from the cylinder head via the exhaust ports 5, 6, 7 and 8 along with the exhaust gases expelled from the cylinder. The fast movement of the fresh air and exhaust gases through the intake and exhaust ports reduces the pressure of the gases in the ports of the cylinder head in the exhaust stroke. The low pressure of the gases inside the ports expedites the exhaustion. In order to further improve the exhaustion, the cam lobe 12 of the cams exclusive for the exhaust valves E and F can be designed in a way that said valves open some degrees of crankshaft angle before the beginning of the exhaust stroke. The mixing of the fresh air and the exhaust gases in the exhaust ports 5, 6, 7 and 8 also reduces the pollution products of the exhaust. When the exhaust valves E and F close in the middle of the sixth stroke, the pressure inside the ports of the cylinder head increases before the intake stroke of the next cycle.

FIG. 5 shows a traditional cam used in a four-stroke engine. The distance that a valve is lifted (valve lift) is marked with 14. The distance that a valve stays up (valve duration) is marked with 13.

As it was aforementioned, the engine is a six-stroke engine. Therefore, a working cycle does not correspond to 720 DEG but 1080 DEG crankshaft angle. In order not to change the camshaft-to-crankshaft ratio used in a four-stroke engine, the radius and circumference of the cams of the valves A, B, C, D, E and F are designed fifty percent larger than the radius and circumference of the traditional ones. So the larger cams cover the six strokes. As a result, the valve duration of the valves A, B, C and D, 15 (FIG. 3) designed for the six stroke engine equals the valve duration of an ordinary valve 13 (FIG. 5) used in a four-stroke engine, (Arc length 15=Arc length 13). As it was aforesaid, the arc length 15 equals the arc length 13 and the circumference of the cams of the valves A, B, C and D are larger than the circumference of the ordinary ones, so the valve lift of the valves A, B, C and D, 16 (FIG. 3) should be reduced with respect to the valve lift of the ordinary one 14 (FIG. 5) so that the cams and rocker arms function together smoothly and efficiently, (length of line 14>length of line 16). The reduction in valve lift of the valves A, B, C and D can be compensated by rocker arms with an approximate ratio of 1 to 1.8 marked with G to H in FIG. 10. The two rocker arms of the four rocker arms allocated for the valves A, B, C and D are marked with 18 and 19 in FIG. 1.

Because of the pressure of the exhaust gases and the same size of the valves A, B, C and D in area, the valve lift of the valves A, B, C and D, 17 (FIG. 3) in the exhaust stroke can be less than the valve lift of the same valves in the intake stroke 16 (FIG. 3) in order to improve energy efficiency, as the area of the intake valves are larger than that of the exhaust valves in an ordinary engine.

In order to prevent fuel-air mixture from wasting in a gasoline engine with a carburetor when the exhaust valves E and F are open, one of the valves A, B, C or D can be assigned as an intake valve and the other three valves can be assigned as intake-exhaust valves. In that case, the intake valve only is connected to the carburetor. Therefore, four valves are open in the intake stroke, but only three valves are open in the exhaust stroke. In that case, the length of the line 14 (FIG. 5) can be equal to the length of the line 16 (FIG. 3) that means all combustion chamber valves in the intake stroke and three combustion chamber valves in the exhaust stroke are open and lifted completely and equally.

Although exhaust gases expelled from the cylinder 21 are expelled from the cylinder head 22 via the exhaust valves E and F in the exhaust stroke, the fifth stroke and the first half of the six stroke, the area of the exhaust valves E and F should be designed proportionately to cover the exhaust gases expelled from cylinder 21 via the intake-exhaust valves A, B, C and/or D completely and efficiently within said strokes.

The cam lobe 9 (FIG. 3) can be designed in a manner that the valves A, B, C and D open earlier for the intake stroke, namely at the end of the sixth stroke. By the same token, the cam lobe 10 can also be designed in a manner that the valves A, B, C and D close later for the exhaust stroke, namely at the beginning of the fifth stroke. Unlike the traditional engine, the problem of overlapping of the combustion chamber valves will not occur in this engine especially at low engine speeds.

Because the valves A, B, C and D open and close rapidly at higher RPMs, there is a very short time for the intake charge to go into the cylinder in the intake stroke. As it was mentioned, the valves E and F close in the middle of the sixth stroke. Of course, with a valve variable timing device, at higher RPMs, the valves E and F can be closed at the end of the sixth stroke. It causes that the fresh air does not stagnate inside the cylinder head in the intake ports 1, 2, 3 and 4 onto the backside of the valves A, B, C and D at higher RPMs. As soon as, the valves A, B, C and D are open at the beginning of the intake stroke, the fresh air goes into the cylinder rapidly. Therefore, more fresh air is rapidly available to the cylinders. This improves the suction especially at higher RPMs.

There are six valves per cylinder in this engine, the four combustion chamber valves (intake-exhaust valves) A, B, C and D and the two exhaust valves E and F in the cylinder head out of the combustion chamber. Four rocker arms are installed for the intake-exhaust valves. The two rocker arms 18 and 19 can be shown in FIG. 1.

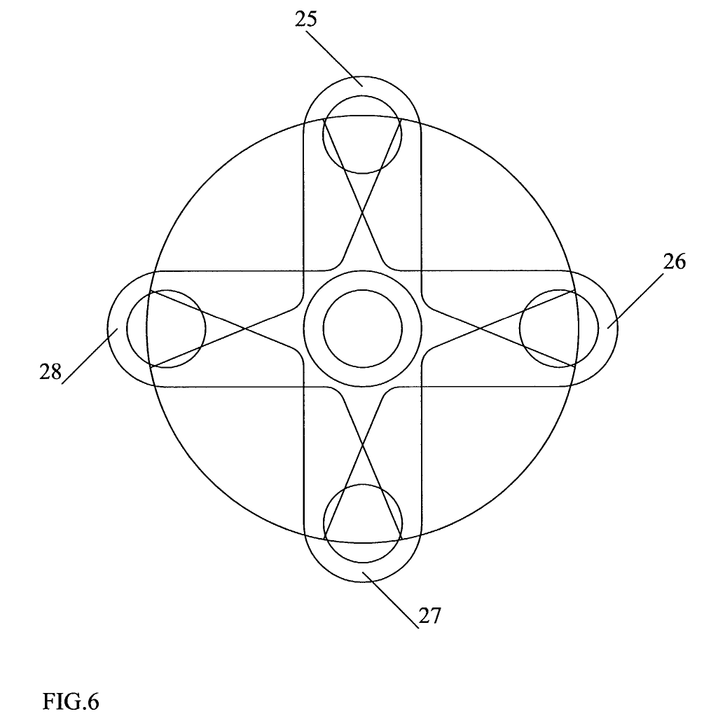

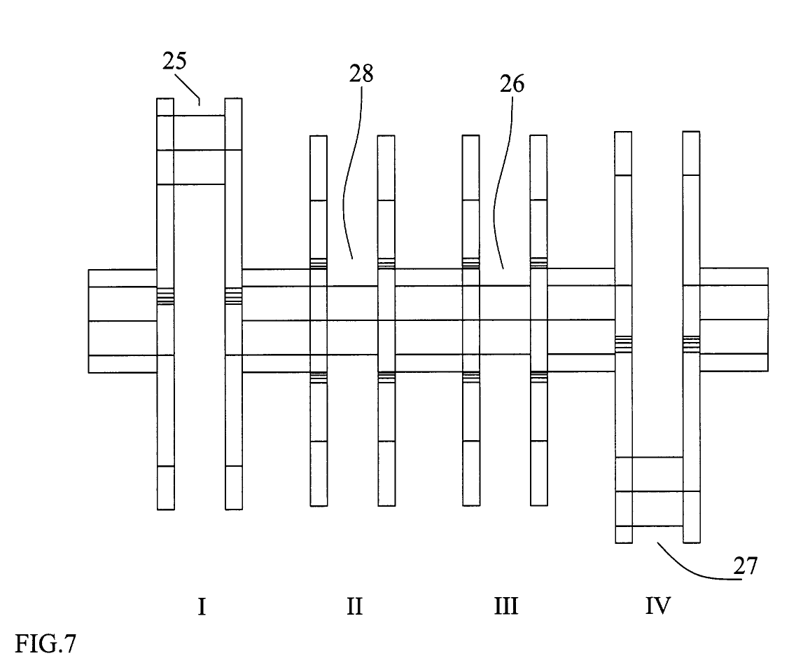

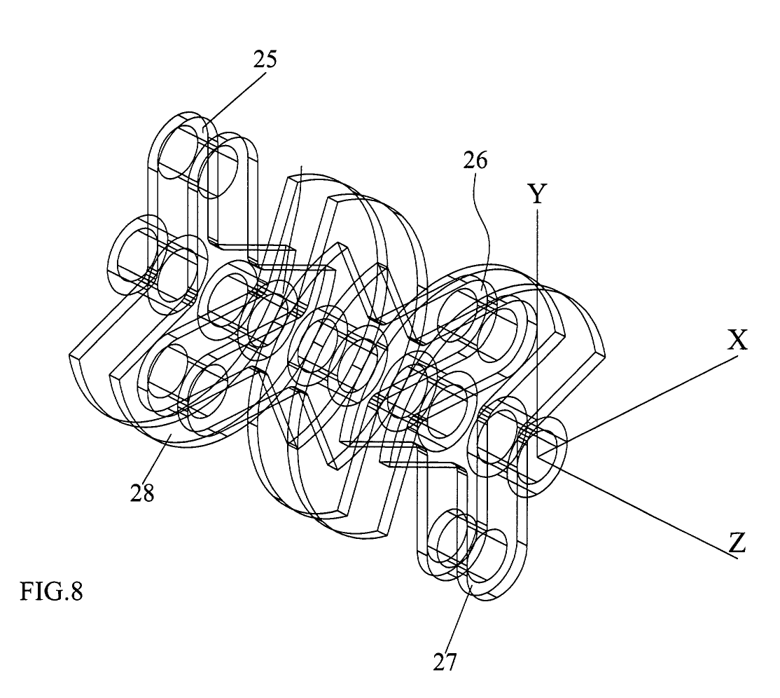

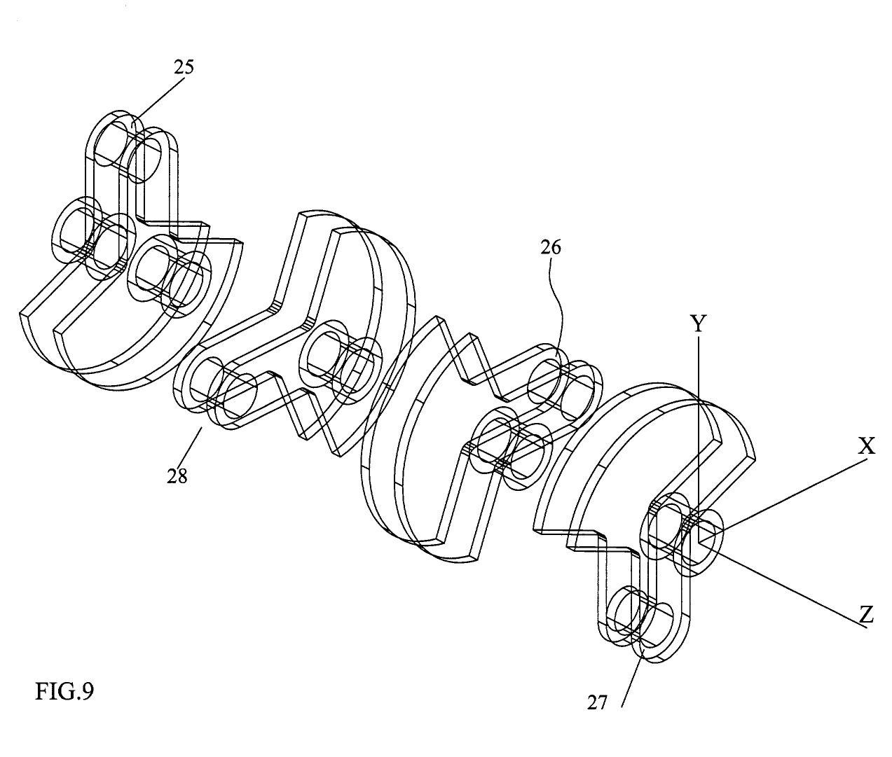

Because a working cycle consisting of an intake stroke, a compression stroke, a power stroke, an exhaust stroke, the fifth stroke and the sixth stroke corresponds to 1080 DEG of crankshaft angle in this engine, two pistons of the two cylinders, having subsequent firing order, are 270 DEG apart on the crankshaft in a six-stroke four-cylinder engine. FIGS. 6, 7, 8 and 9 show different views of a crankshaft especially designed for the six-stroke four-cylinder engine. FIG. 6 shows symmetrical position of the journals designed for the six-stroke four-cylinder engine. In FIGS. 6, 7, 8 and 9, journals 25, 26, 27, 28 (firing order 1-3-4-2) are related to the first cylinder, the third cylinder, the fourth cylinder and the second cylinder respectively in the six-stroke and four-cylinder engine (not shown). The vibration of the six-stroke four-cylinder engine utilizing said crankshaft is less than that of a four-stroke four-cylinder engine with a traditional crankshaft.

Two pistons of the two cylinders, having subsequent firing order, are 180 DEG apart on the crankshaft in a six-stroke six-cylinder engine related to the invention (not shown). Therefore, the form of the crankshaft used in the six-stroke six-cylinder engine is like the form of the crankshaft used in a four-stroke four-cylinder engine with two more journals. About other multi-cylinder engines, you divide the number 1080 by the number of cylinders, for example 6 or 8, in order to find the interval between power strokes.

What I claim as my invention is:

1. A six-stroke internal combustion engine with reciprocating piston wherein each cycle comprises an intake stroke, a compression stroke, a power stroke, an exhaust stroke, the fifth stroke and the sixth stroke. A working cycle therefore corresponds to 1080 DEG crankshaft angle. In this engine:
a) the fifth stroke and the sixth stroke are considered to provide an interval between the exhaust stroke and the intake stroke of the next cycle. As a result, the exhaust gases expelled from a cylinder in the exhaust stroke are expelled completely from the cylinder head within the interval and are not sucked into the cylinder in the intake stroke of the next cycle. On the fifth stroke a piston moves downward from a top dead center to a bottom dead center, and on the sixth stroke the piston moves upward from the bottom dead center to the top dead center.
b) two valves of four combustion chamber valves open approximately in the middle of the fifth stroke and close in the middle of the sixth stroke. The other two combustion chamber valves are closed in the fifth stroke and in the sixth stroke.

2. The internal combustion engine as recited in claim 1 wherein valves A, B, C and D (FIGS. 1 and 2) are installed in the cylinder head in the combustion chamber for each cylinder. The combustion chamber valves A, B, C and D, which are named intake-exhaust valves or (inlet-outlet valves), open in the intake stroke as intake valves, and also open in the exhaust stroke as exhaust valves. Practically, the area of the intake and exhaust valves in this engine increases up to one hundred percent with respect to the area of the valves in a traditional four valve per cylinder engine (two intake valves & two exhaust valves) without adding even a valve in the combustion chamber. Said valves close in the compression and power strokes.

3. The internal combustion engine as recited in claim 1 wherein exhaust valves E and F (FIGS. 1 and 2) are installed in the cylinder head out of the combustion chamber. Said valves are open in the exhaust stroke, the fifth stroke and the first half of the sixth stroke. They are completely closed in the intake stroke, the compression stroke, the power stroke and the second half of the sixth stroke in order to provide a one-way flow of the intake charge sucked into the cylinder via intake ports 1, 2, 3 and 4 and the intake-exhaust valves in the intake stroke and exhaust gases expelled from the cylinder and cylinder head via the same intake-exhaust valves and exhaust ports 5, 6, 7 and 8 in the exhaust stroke. As a result, the intake charge goes into the cylinder head continuously via the intake ports due to the suction caused by the previous intake stroke, and exhaust gases do not go into the intake ports in the exhaust stroke.

4. The internal combustion engine as recited in claim 1 wherein the intake-exhaust valves A and D open approximately in the middle of the fifth stroke and close in the middle of the sixth stroke so that:
a) the pressure inside the cylinder does not reduce while a piston moves downward in the second half of the fifth stroke and moves upward in the first half of the sixth stroke. In that case, engine operates smoothly and efficiently.
b) the fresh air sucked into the cylinder in the second half of the fifth stroke mixes with the exhaust gases remained in the combustion chamber of the cylinder from the previous exhaust stroke. It reduces the proportion of unburnt fractions in the exhaust gases.
c) in the first half of the sixth stroke, exhaust gases remained in the cylinder from the previous exhaust stroke are expelled from the cylinder along with the fresh air which was sucked into the cylinder in the second half of the fifth stroke. Therefore, more fresh air is available in the cylinder in the intake stroke of the next cycle.

5. The internal combustion engine as recited in claim 1 wherein especial cams FIG. 3 are designed for the intake-exhaust valves. Each of said cams has cam lobe 9 to open said valves in the intake stroke and cam lobe 10 to open the same valves in the exhaust stroke. The cams of the intake-exhaust valves A and D also have cam lobe 11 to open the valves A and D approximately in the middle of the fifth stroke and close them in the middle of the sixth stroke.

6. The internal combustion engine as recited in claim 1 wherein especial cams FIG. 4 are designed for the exhaust valves E and F. Each of said cams has a com lobe 12 to open the exhaust valves E and F at the beginning of the exhaust stroke. Said cams cause the exhaust valves E and F to begin closing in the middle of the exhaust stroke. Said valves are completely closed in the middle of the sixth stroke due to the especial form and profile of the cam lobe 12.

7. The internal combustion engine as recited in claim 1 wherein the intake ports 1, 2, 3 and 4 and the exhaust ports 5, 6, 7 and 8 are connected to each other in the cylinder head FIGS. 1 and 2 so that:
a) the intake charge goes into the cylinder via the intake ports 1, 2, 3 and 4 and the intake-exhaust valves A, B, C and D in the intake stroke, and the exhaust gases are expelled from the cylinder and cylinder head via the same intake-exhaust valves and the exhaust ports 5, 6, 7 and 8 in the exhaust stroke.
b) fresh air sucked into the intake ports 1, 2, 3 and 4 due to the suction caused by the previous intake stroke is expelled from the exhaust ports 5, 6, 7 and 8 along with the exhaust gases in the exhaust stroke. Because exhaust valves E and F are open in the exhaust stroke, the fifth stroke and the first half of the sixth stroke, gases begin flowing in the ports of the cylinder head rapidly. Therefore, the pressure of the gases in the ports of the cylinder head reduces. As a result, the pressure reduction causes the exhaust gases to be expelled from the cylinder and cylinder head rapidly; in other words, it improves the exhaustion. When the exhaust valves E and F are closed in the middle of the sixth stroke, the pressure inside the cylinder head in the intake ports increases before the intake stroke of the next cycle.
c) the fresh air sucked into the intake ports 1, 2, 3 and 4 mixes with the exhaust gases expelled from the cylinder in the exhaust ports 5, 6, 7 and 8 in the cylinder head in the exhaust stroke, the fifth stroke and the first half of the sixth stroke. It also reduces the pollution products of the exhaust.

8. The internal combustion engine as recited in claim 1 wherein one of the four combustion chamber valves A, B, C or D is assigned as an intake valve and the other three valves are assigned as intake-exhaust valves in order to prevent fuel-air mixture from wasting in a gasoline type with a carburetor in the exhaust stroke, the fifth stroke and the first half of the sixth stroke. Said intake valve is only connected to the carburetor.

9. The internal combustion engine as recited in claim 1 comprising an especially designed crankshaft for a six-stroke four-cylinder engine FIGS. 6, 7, 8 and 9. Symmetrical position of journals in said crankshaft reduces the vibration of this engine with respect to a four-stroke four-cylinder engine with a traditional crankshaft. In the six-stroke four-cylinder engine, two pistons of the cylinders, having subsequent firing order, are 270 DEG apart on the crankshaft. You divide 1080 by the number of cylinders, for example 6 or 8, in order to find the interval between power strokes and make a proper crankshaft for multi-cylinder engines. For instance, in a six-stroke six-cylinder engine related to the invention, two pistons of the two cylinders, having subsequent firing order, are 180 DEG apart on the crankshaft.

10. In the internal combustion engine recited in claim 1, the exhaust valves E and F can be closed at the end of the sixth stroke at higher RPMs by means of a variable valve timing device. As a result, the fresh air does not remain stagnant inside the cylinder head in the intake ports 1, 2, 3 and 4 onto the backside of the valves A, B, C and D during the second half of the sixth stroke at higher RPMs. As soon as, the valves A, B, C and D open at the beginning of the intake stroke, the fresh air goes into the cylinder rapidly. Therefore, more fresh air is rapidly available to the cylinders. This improves the suction especially at higher RPMs when the period of the time that the valves are open is greatly reduced.

11. The internal combustion engine as recited in claim 1 is named Bazmi's Six Stroke Engine. This invention is practicable in gasoline and diesel engines and also in multi-cylinder engines.
